(19) United States
(12) Patent Application Publication
(10) Pub. No.: US 2014/0034518 A1
(43) Pub. Date: Feb. 6, 2014

(54) Paint Storage Apparatus

(71) Applicant: Ronald E Stevenson, JR., Coventry, RI (US)

(72) Inventor: Ronald E Stevenson, JR., Coventry, RI (US)

(21) Appl. No.: 13/929,968

(22) Filed: Jun. 28, 2013

Related U.S. Application Data
(60) Provisional application No. 61/666,723, filed on Jun. 29, 2012.

(51) Int. Cl. B44D 3/14

(52) U.S. Cl. CPC B44D 3/14
USPC 206/1.7

(57) ABSTRACT

Disclosed is an apparatus for the storage of paint. The apparatus comprises a tray with recesses designed to hold containers of different types and/or colors of paints. The tray is constructed to allow a dispenser and/or applicator to access the containers for the efficient transfer of paint. The trays are further built to allow the trays to be stably stacked upon one another. Trays and containers can be made with materials that are sufficiently clear to allow for the identification of stored paint. Dispensers and/or applicators can be attached to the container caps for transfer of paint into and out of the containers.

The present application claims priority to U.S. Provisional Application Ser. No. 61/666,723, filed on Jun. 29, 2012.

### FIELD OF THE DISCLOSURE

The present disclosure relates generally to paint storage. Particularly, the present disclosure relates to the storage of one or more paints. More particularly, the present disclosure relates to the storage and organization of one or more paints.

### BACKGROUND

Painting generally requires the use of one or more different types and/or colors of paints. Typically, after painting, one or more partially filled paint containers remain. These containers are generally stored and/or stacked in their original container for future use, such as touch-ups. Frequently, the original containers are difficult to reseal or are not designed to be resealed Depending on need, these paints can come in containers of different sizes and shapes making organized storage nearly impossible. Stacks of the original containers can be spatially inefficient and a potentially dangerous falling hazard. Stacks are also inconvenient when searching for a specific paint which requires the containers to be moved to identify the paint. Furthermore, these stacks are unsightly due to paint spillage on the sides of the container that is inherent to painting. This paint spillage can further complicate the identification process by making the paint labels illegible or difficult to read.

Therefore, it is desirable to have an apparatus that allows for the easy identification of and access to stored paints. Further, it is desirable to have an apparatus that is clean, convenient to transfer unused paints into, spatially efficient, easily to manipulate, and stable.

### SUMMARY

It is an object of the present disclosure to provide an apparatus that allows for the storage of paints. It is another object of the present disclosure is to provide a spatially efficient paint storage apparatus. A further object of the present disclosure is to make the identification and acquisition of a desired paint more efficient.

The present disclosure achieves these and other objectives by providing a paint storage apparatus that can be stacked on one another. The paint storage apparatus has at least one container, at least one tray, and one or more recesses. The containers have an inner volume to accommodate at least one paint. The trays have an upper and a lower surface. Recesses having a mouth at the upper surface of the tray and at least one wall form a cavity able to accommodate at least one container. An outer body of the recess extends from the lower surface of the tray.

At least one cap, applicator, and/or dispenser can attach to the container. At least one cap can be used to seal a container. An applicator and/or a dispenser capable of accessing the inner volume of the container may be used to facilitate the transfer of paint. The applicator and/or a dispenser can also be attached to the cap. In one embodiment, the applicator is a brush that extends from the cap into the inner volume of the container. The trays may also be adapted to accommodate a dispenser and/or an applicator to help transfer paint from the containers while the containers are in the recesses of the tray.

To assist with the identification of the paint contents, the container and/or the tray may be clear. A means for identifying paints (such as a label, writing on the container, writing on the tray) may also be used for the identification of paint.

The trays may be adapted for easier access and efficient storage. In one embodiment, the tray has at least one handle. The trays may also have recesses capable of accommodating containers of different sizes. In one embodiment, the trays have two or more recesses allowing the storage of multiple paint types and/or colors in a single tray. Furthermore, the recesses may be able to accommodate containers of different sizes. The container can also attach to the tray allowing the container to be immobilized when in the tray.

Efficient spatial storage is further achieved by stacking trays. The trays are stacked by placing the recess outer body of one tray in the recess mouth of a second tray. In doing so, multiple trays may be stacked upon one another. In one embodiment, the recess outer body of one tray can removably attach to the recess mouth of the second tray allowing stacked trays to lock into one another. The recess outer body may be used to seal a container. This also allows trays to be stacked when the outer body recess of the first tray can be placed on a container in the recess of a second tray sealing the contents.

### BRIEF DESCRIPTION OF THE FIGURES

FIG. 1 is a perspective view of a 6 recess tray holding 6 paint containers according to the present disclosure.

FIG. 2 is an image of a container with a brush under the cap according to the present disclosure.

FIG. 3 is a representative top view image of a funnel according to the present disclosure.

FIG. 4 is a representative cross-sectional view of 3 stacked trays.

FIG. 5 is an image of 2 stacked trays.

### DETAILED DESCRIPTION

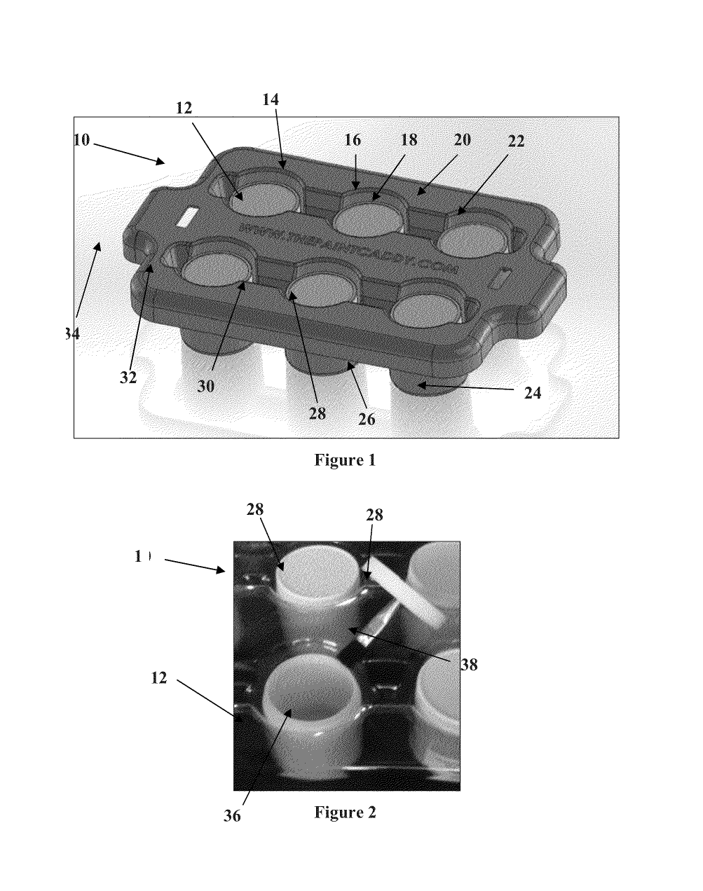

Embodiments of the present disclosure are illustrated in FIG. 1-8. FIG. 1 displays a 6 recess paint storage apparatus 10 of the present disclosure with 6 containers 12 in the recesses 16 in a tray 14. The recesses 16 have a mouth 18 at the upper surface 20 of the tray 14 and a wall 22 forming a cavity that accommodates the container 16. A recess outer body 24 extends from a lower surface 26 of the tray. A cap 28 seals the container 12. The tray has a notch 30 and 32 to strengthen tray 14 and to allow access to the container 16. A handle 34 is attached to the tray 14 for easy access to the containers 12 and/or control over the tray 14.

FIG. 2 is a close-up image of the recess 16 of the storage apparatus accommodating a container 12 of the present disclosure. The container 12 has an inner volume 36 to accommodate at least one paint. The cap 28 has a brush 38 attached. When the cap 28 seals the container 12, the brush 38 extends into the inner volume 36 of the container 12. The container 12 and the tray 14 are sufficiently clear to allow for identification of the contents of the container 12. In this embodiment, the container 12 can be made from commercially available materials, such as a clear no. 2 plastic grade High Density Polyethylene (HDPE) or a similar plastic, and holds approximately 8 ounces of paint. This embodiment also has a ⅜″ brush 38 that extends into the container 12 when the cap 28 seals the container 12.

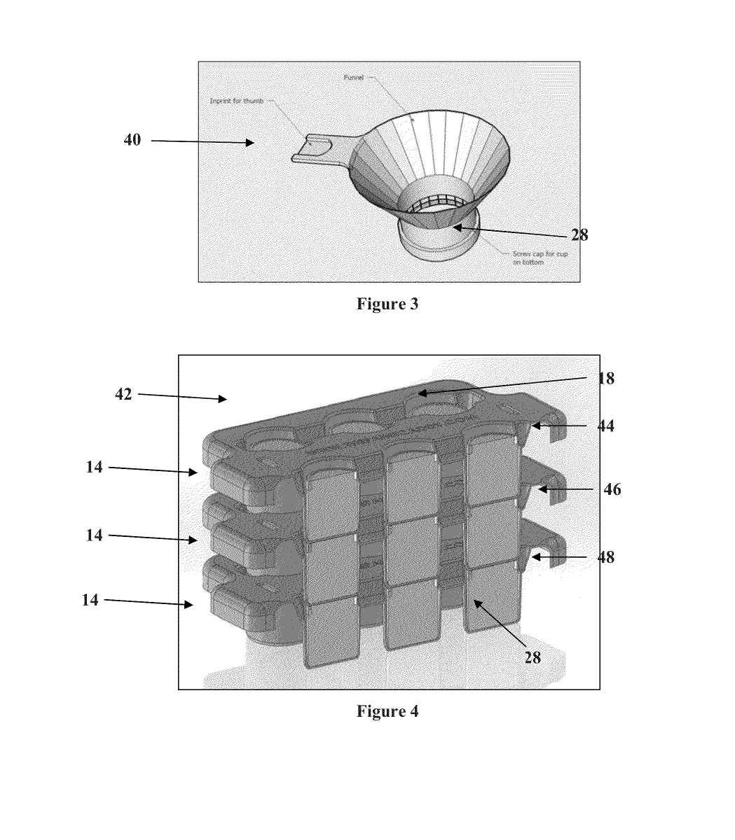

FIG. 3 displays a dispenser 40. In this embodiment, the dispenser 40 is a funnel. The funnel is connected to a cap 28 allowing the dispenser 40 to be attached to a container.

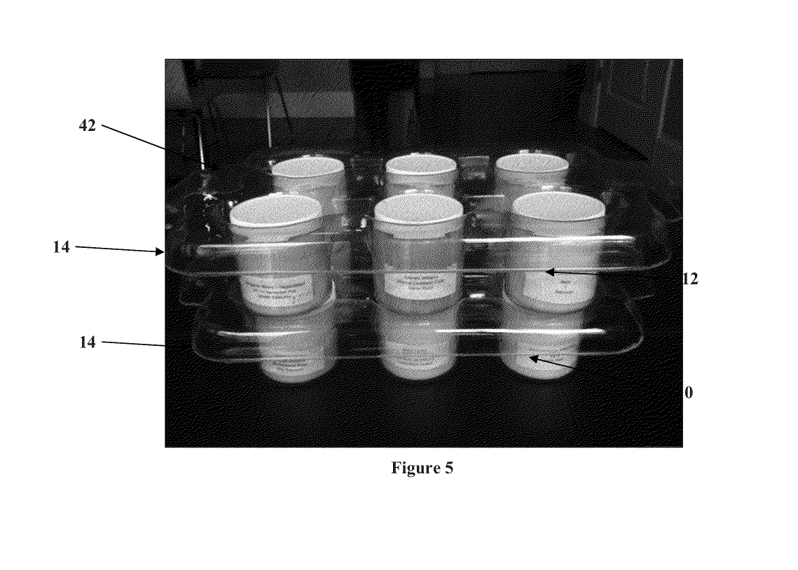

FIG. 4 displays a stack 42 of 3 trays 14. By placing the recess outer body 24 of one tray 14 in the recess mouth 18 of another tray 14, the trays 14 can be stacked. In this embodiment, the recess outer body 24 of a first tray 44 is in the mouth 18 of a second tray 46. The recess outer body 24 of a second tray 46 can be placed in the mouth 18 of a third tray 48. In one embodiment, the recess outer body 24 of one tray 14 can removably attach to a second tray 14, locking the trays 14 together.

FIG. 5 is an image of a stack 42 of 2 trays 14. The trays 14 sufficiently clear to allow a label 50 to be seen to identify the contents of the containers 12.

Although the embodiments of the present disclosure have been described herein, the above description is merely illustrative. Further modification of the invention herein disclosed will occur to those skilled in the respective arts and all such modifications are deemed to be within the scope of the invention as defined by the appended claims.

What is claimed is:

1. A paint storage apparatus comprising:
a. at least one container having an inner volume to accommodate at least one paint;
b. at least one tray having an upper surface and a lower surface; and
c. one or more recesses having a mouth at the upper surface of the tray, at least one wall extending downward from the tray upper surface forming cavity adapted to accommodate the container, and an outer body extending from the lower surface of the tray.

2. The paint storage apparatus of claim 1, further comprising one or more applicators capable of accessing the inner volume of at least one container attaches to the containers.

3. The paint storage apparatus of claim 1, further comprising one or more dispensers capable of accessing the inner volume of at least one container attaches to the containers.

4. The paint storage apparatus of claim 1, further comprising at least one cap to seal said container.

5. The paint storage apparatus of claim 4, wherein one or more dispensers are attached to the cap.

6. The paint storage apparatus of claim 4, wherein one or more applicators are attached to the cap.

7. The paint storage apparatus of claim 6, wherein the applicator is a brush extending from the cap into the inner volume of the container.

8. The paint storage apparatus of claim 1, wherein the upper surface of said tray is adapted to accommodate one or more dispensers.

9. The paint storage apparatus of claim 1, wherein the upper surface of said tray is adapted to accommodate one or more applicators.

10. The paint storage apparatus of claim 1, wherein the containers are sufficiently clear to allow for identification of one or more paints.

11. The paint storage apparatus of claim 1, wherein the trays are sufficiently clear to allow for identification of one or more paints.

12. The paint storage apparatus of claim 1, further comprising a means for identifying the content of the container.

13. The paint storage apparatus of claim 1, further comprising a means for identifying the contents of the tray.

14. The paint storage apparatus of claim 1, further comprising at least one handle attached to one or more trays.

15. The paint storage apparatus of claim 1, wherein the tray has two or more recesses capable of accommodating containers of one or more sizes.

16. The paint storage apparatus of claim 1, wherein the recesses are capable of accommodating containers of one or more sizes.

17. The paint storage apparatus of claim 1, wherein the container attaches to the tray.

18. The paint storage apparatus of claim 1, wherein said trays are stackable by placing the recess outer body of a first tray in the recess mouth of a second tray.

19. The paint storage apparatus of claim 18, wherein the recess outer body of the first tray removably attaches to the recess mouth of the second tray.

20. The paint storage apparatus of claim 1, wherein the outer body recess of a first tray seals one or more containers.
